(19) United States
(12) Patent Application Publication
(10) Pub. No.: US 2024/0380543 A1
(43) Pub. Date: Nov. 14, 2024

(54) FACILITATING IMPROVED DECODING OF PUNCTURED SYNCHRONIZATION SIGNAL BLOCK DATA

(71) Applicant: Nokia Technologies Oy, Espoo (FI)

(72) Inventors: Sami-Jukka HAKOLA, Oulu (FI); Esa Tapani TIIROLA, Oulu (FI); Kari Juhani HOOLI, Oulu (FI); Jorma Johannes KAIKKONEN, Oulu (FI); Pasi Eino Tapio KINNUNEN, Oulu (FI)

(21) Appl. No.: 18/686,689

(22) PCT Filed: Sep. 3, 2021
(86) PCT No.: PCT/EP2021/074333

§ 371 Date: Feb. 26, 2024

(51) Int. Cl. H04L 5/00; H04L 1/00

(52) U.S. Cl. CPC H04L 5/005; H04L 1/0013; H04L 1/0036

(57) ABSTRACT

Various example embodiments may relate to punctured transmission of data within synchronization signal blocks. An apparatus may obtain data for transmission on a data channel of a synchronization signal block of a transmission frame and allocate the data to resource elements of the data channel. The allocation of the data may be dependent on the frame number of the transmission frame. The apparatus may further puncture one or more resource elements at edge(s) of the synchronization signal block and transmit the synchronization signal block. Another apparatus may receive the synchronization signal block and decode the data. Apparatuses, methods, and computer programs are disclosed.

### TECHNICAL FIELD

Various example embodiments generally relate to the field of wireless communications. Some example embodiments relate to punctured transmission of synchronization block data and decoding of punctured synchronization block data.

### BACKGROUND

Wireless communication networks may transmit synchronization signal blocks to enable initial access to the network. In addition to synchronization signals, a synchronization signal block (SSB) may carry a data channel, such as for example a physical broadcast channel (PBCH). In some applications it may be desired to operate the wireless communication system at a narrow bandwidth, for which the synchronization signal block was not originally designed.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. The scope of protection sought for various embodiments of the present disclosure is set out by the independent claims.

Example embodiments of the present disclosure improve interference management by enabling flexible switching between centralized and distributed interference management modes. This and other benefits may be achieved by the features of the independent claims. Further advantageous implementation forms are provided in the dependent claims, the description, and the drawings.

According to a first aspect, an apparatus may comprise at least one processor and at least one memory including computer program code, the at least one memory and the computer code configured to, with the at least one processor, cause the apparatus at least to: obtain data for transmission on a data channel of a synchronization signal block of a transmission frame; allocate the data to resource elements of the data channel, wherein the allocation of the data to the resource elements of the data channel is dependent on a frame number of the transmission frame; puncture one or more resource elements at at least one edge of the synchronization signal block; and transmit a portion of the data on the data channel using available resource elements for the synchronization signal block after the puncturing.

According to an example embodiment of the first aspect, the synchronization signal block may comprise at least one synchronization signal.

According to an example embodiment of the first aspect, the data channel may comprise a physical broadcast channel.

According to an example embodiment of the first aspect, the synchronization signal block may comprise a plurality of symbols, each of the plurality of symbols comprising a plurality of resource elements, wherein at least one of the plurality of symbols comprises a synchronization signal on a subset of the plurality of resource elements, and wherein the plurality of symbols comprise the resource elements of the data channel.

According to an example embodiment of the first aspect, the at least one memory and the computer code may be further configured, with the at least one processor, to cause the apparatus to: determine a pair of scrambling and resource allocation schemes based on the frame number of the transmission frame; and scramble the data and allocate the data to the resource elements of the data channel based on the determined pair of scrambling and resource allocation schemes.

According to an example embodiment of the first aspect, the allocation of the data to the resource elements of the data channel and the scrambling of the data may be dependent on a subset of bits for the frame number of the transmission frame.

According to an example embodiment of the first aspect, the subset of bits may comprise third and second least significant bits for the frame number.

According to an example embodiment of the first aspect, the allocation of the data to the resource elements of the data channel may comprise interleaving the data based on an interleaving pattern, wherein the interleaving pattern is dependent on the frame number of the transmission frame.

According to an example embodiment of the first aspect, the interleaving may be performed by an interleaver of a channel encoder.

According to an example embodiment of the first aspect, the allocation of the data to the resource elements of the data channel may be dependent on the frame number of the transmission frame for a plurality of consecutive transmissions of the synchronization signal block, and parameters of the channel encoder may be fixed over the plurality of consecutive transmissions of the synchronization signal block.

According to an example embodiment of the first aspect, channel encoder may comprise a polar encoder.

According to an example embodiment of the first aspect, the allocation of the data to the resource elements of the data channel may comprise mapping the data to the resource elements of the data channel based on a resource element mapping pattern, wherein the resource element mapping pattern is dependent on the frame number of the transmission frame.

According to an example embodiment of the first aspect, the resource element mapping pattern may comprise resource elements or blocks of resource elements of the data channel cyclically shifted based on the frame number of the transmission frame.

According to an example embodiment of the first aspect, a number of the blocks of resource elements of the data channel may be higher or equal to a number of combinations of the subset of bits for the frame number of the transmission frame.

According to an example embodiment of the first aspect, a subset of the resource elements of the data channel may overlap with the at least one synchronization signal in frequency, and resource element mapping patterns associated with different frame numbers may cause different data to be mapped to the subset of the resource elements of the data channel overlapping with the at least one synchronization signal in frequency.

According to an example embodiment of the first aspect, the synchronization signal block may comprise: a first orthogonal frequency division multiplexing (OFDM) symbol comprising a primary synchronization signal on a subset of a plurality of subcarriers; a second OFDM symbol comprising resource elements of the data channel at the plurality of subcarriers; a third ODFM symbol comprising a secondary synchronization signal on the subset of the plurality of subcarriers and resource elements of the data channel at edges of the plurality of subcarriers; and a fourth OFDM symbol comprising resource elements of the data channel at the plurality of subcarriers.

According to an example embodiment of the first aspect, the puncturing of one or more resource elements at the at least one edge of the synchronization signal block may comprise not transmitting data allocated to subcarriers at the at least one edge of the synchronization signal block.

According to a second aspect, a method may comprise: obtaining data for transmission on a data channel of a synchronization signal block of a transmission frame; allocating the data to resource elements of the data channel, wherein the allocation of the data to the resource elements of the data channel is dependent on a frame number of the transmission frame; puncturing one or more resource elements at at least one edge of the synchronization signal block; and transmitting a portion of the data on the data channel using available resource elements for the synchronization signal block after the puncturing.

According to an example embodiment of the second aspect, the synchronization signal block may comprise at least one synchronization signal.

According to an example embodiment of the second aspect, the data channel may comprise a physical broadcast channel.

According to an example embodiment of the second aspect, the synchronization signal block may comprise a plurality of symbols, each of the plurality of symbols comprising a plurality of resource elements, wherein at least one of the plurality of symbols comprises a synchronization signal on a subset of the plurality of resource elements, and wherein the plurality of symbols comprise the resource elements of the data channel.

According to an example embodiment of the second aspect, the method may further comprise: determining a pair of scrambling and resource allocation schemes based on the frame number of the transmission frame; and scrambling the data and allocate the data to the resource elements of the data channel based on the determined pair of scrambling and resource allocation schemes.

According to an example embodiment of the second aspect, the allocation of the data to the resource elements of the data channel and the scrambling of the data may be dependent on a subset of bits for the frame number of the transmission frame.

According to an example embodiment of the second aspect, the subset of bits may comprise third and second least significant bits for the frame number.

According to an example embodiment of the second aspect, the allocation of the data to the resource elements of the data channel may comprise interleaving the data based on an interleaving pattern, wherein the interleaving pattern is dependent on the frame number of the transmission frame.

According to an example embodiment of the second aspect, the method may further comprise: encoding the data with a channel encoder; and interleaving the data with an interleaver of the channel encoder.

According to an example embodiment of the second aspect, the allocation of the data to the resource elements of the data channel may be dependent on the frame number of the transmission frame for a plurality of consecutive transmissions of the synchronization signal block, and parameters of the channel encoder may be fixed over the plurality of consecutive transmissions of the synchronization signal block

According to an example embodiment of the second aspect, channel encoder may comprise a polar encoder.

According to an example embodiment of the second aspect, the allocation of the data to the resource elements of the data channel may comprise mapping the data to the resource elements of the data channel based on a resource element mapping pattern, wherein the resource element mapping pattern is dependent on the frame number of the transmission frame.

According to an example embodiment of the second aspect, the resource element mapping pattern may comprise resource elements or blocks of resource elements of the data channel cyclically shifted based on the frame number of the transmission frame.

According to an example embodiment of the second aspect, a number of the blocks of resource elements may be higher or equal to a number of combinations of the subset of bits for the frame number of the transmission frame.

According to an example embodiment of the second aspect, a subset of the resource elements of the data channel may overlap with the at least one synchronization signal in frequency, and resource element mapping patterns associated with different frame numbers may cause different data to be mapped to the subset of the resource elements of the data channel overlapping with the at least one synchronization signal in frequency.

According to an example embodiment of the second aspect, the synchronization signal block may comprise: a first orthogonal frequency division multiplexing (OFDM) symbol comprising a primary synchronization signal on a subset of a plurality of subcarriers; a second OFDM symbol comprising resource elements of the data channel at the plurality of subcarriers; a third ODFM symbol comprising a secondary synchronization signal on the subset of the plurality of subcarriers and resource elements of the data channel at edges of the plurality of subcarriers; and a fourth OFDM symbol comprising resource elements of the data channel at the plurality of subcarriers.

According to an example embodiment of the second aspect, the puncturing of the one or more resource elements at the at least one edge of the synchronization signal block may comprise not transmitting data allocated to subcarriers at the at least one edge of the synchronization signal block.

According to a third aspect, a computer program or a computer program product may comprise instructions for causing an apparatus to perform at least the following: obtaining data for transmission on a data channel of a synchronization signal block of a transmission frame; allocating the data to resource elements of the data channel, wherein the allocation of the data to the resource elements of the data channel is dependent on a frame number of the transmission frame; puncturing one or more resource elements at at least one edge of the synchronization signal block; and transmitting a portion of the data on the data channel using available resource elements for the synchronization signal block after the puncturing. The computer program or the computer program product may further comprise instructions for causing the apparatus to perform any example embodiment of the method of the second aspect.

According to a fourth aspect, an apparatus may comprise means for obtaining data for transmission on a data channel of a synchronization signal block of a transmission frame; means for allocating the data to resource elements of the data channel, wherein the allocation of the data to the resource elements of the data channel is dependent on a frame number of the transmission frame; means for puncturing one or more resource elements at at least one edge of the synchronization signal block; and means for transmitting a portion of the data on the data channel using available resource elements for the synchronization signal block after the puncturing. The apparatus may further comprise means for performing any example embodiment of the method of the second aspect.

According to a fifth aspect, an apparatus may comprise at least one processor and at least one memory including computer program code, the at least one memory and the computer code configured to, with the at least one processor, cause the apparatus at least to: receive a synchronization signal block of a transmission frame, wherein the synchronization signal block comprises a data channel; extract data from resource elements of the data channel, wherein the extraction of the data from the resource elements of the data channel is dependent on a frame number of the transmission frame; and decode the data.

According to an example embodiment of the fifth aspect, the synchronization signal block may comprise at least one synchronization signal.

According to an example embodiment of the fifth aspect, the data channel may comprise a physical broadcast channel.

According to an example embodiment of the fifth aspect, the synchronization signal block may comprise a plurality of symbols, each of the plurality of symbols comprising a plurality of resource elements, wherein at least one of the plurality of symbols comprises a synchronization signal on a subset of the plurality of resource elements, and wherein the plurality of symbols comprise the resource elements of the data channel.

According to an example embodiment of the fifth aspect, the at least one memory and the computer code may be further configured, with the at least one processor, to cause the apparatus to: determine a pair of scrambling and resource allocation schemes based on the frame number of the transmission frame; and extract the data from the resource elements of the data channel and de-scramble the data based on the determined pair of scrambling and resource allocation schemes.

According to an example embodiment of the fifth aspect, the extraction of the data from the resource elements of the data channel and the de-scrambling of the data may be dependent on a subset of bits for the frame number of the transmission frame.

According to an example embodiment of the fifth aspect, the subset of bits may comprise third and second least significant bits for the frame number.

According to an example embodiment of the fifth aspect, the extraction of the data from the resource elements of the data channel may comprise de-interleaving the data based on an interleaving pattern, wherein the interleaving pattern is dependent on the frame number of the transmission frame.

According to an example embodiment of the fifth aspect, the deinterleaving may be performed by a de-interleaver of a channel decoder.

According to an example embodiment of the fifth aspect, the channel decoder may comprise a polar decoder.

According to an example embodiment of the fifth aspect, allocation of the data to the resource elements of the data channel may dependent on the frame number of the transmission frame for a plurality of consecutive transmissions of the synchronization signal block, and the at least one memory and the computer code are further configured, with the at least one processor, to cause the apparatus to: decode the data from the plurality of consecutive transmissions of the synchronization signal block, wherein parameters of the channel decoder are fixed over the plurality of consecutive transmissions of the synchronization signal block; and combine the data decoded from the plurality of consecutive transmissions of the synchronization signal blocks.

According to an example embodiment of the fifth aspect, the extraction of the data from the resource elements of the data channel may comprise de-mapping the data from the resource elements of the data channel based on a resource element mapping pattern, wherein the resource element mapping pattern is dependent on the frame number of the transmission frame.

According to an example embodiment of the fifth aspect, the resource element mapping pattern may comprise resource elements or blocks of resource elements of the data channel cyclically shifted based on the frame number of the transmission frame.

According to an example embodiment of the fifth aspect, a number of the blocks of resource elements may be higher or equal to a number of combinations of the subset of bits for the frame number of the transmission frame.

According to an example embodiment of the fifth aspect, a subset of the resource elements of the data channel may overlap with the at least one synchronization signal in frequency, and resource element mapping patterns associated with different frame numbers may cause different data to be carried on the subset of the resource elements of the data channel overlapping with the at least one synchronization signal in frequency.

According to an example embodiment of the fifth aspect, the synchronization signal block may comprise: a first orthogonal frequency division multiplexing (OFDM) symbol comprising a primary synchronization signal on a subset of a plurality of subcarriers; a second OFDM symbol comprising resource elements of the data channel at the plurality of subcarriers; a third ODFM symbol comprising a secondary synchronization signal on the subset of the plurality of subcarriers and resource elements of the data channel at edges of the plurality of subcarriers; and a fourth OFDM symbol comprising resource elements of the data channel at the plurality of subcarriers.

According to an example embodiment of the fifth aspect, the at least one memory and the computer code may be further configured, with the at least one processor, to cause the apparatus to: jointly decode the data based on a plurality of the synchronization signal blocks.

According to a sixth aspect, a method may comprise: receiving a synchronization signal block of a transmission frame, wherein the synchronization signal block comprises a data channel; extracting data from resource elements of the data channel, wherein the extraction of the data from the resource elements of the data channel is dependent on a frame number of the transmission frame; and decoding the data.

According to an example embodiment of the sixth aspect, the synchronization signal block may comprise at least one synchronization signal.

According to an example embodiment of the sixth aspect, the data channel may comprise a physical broadcast channel.

According to an example embodiment of the sixth aspect, the synchronization signal block may comprise a plurality of symbols, each of the plurality of symbols comprising a plurality of resource elements, wherein at least one of the plurality of symbols comprises a synchronization signal on a subset of the plurality of resource elements, and wherein the plurality of symbols comprise the resource elements of the data channel.

According to an example embodiment of the sixth aspect, the method may further comprise: determining a pair of scrambling and resource allocation schemes based on the frame number of the transmission frame; and extracting the data from the resource elements of the data channel and de-scrambling the data based on the determined pair of scrambling and resource allocation schemes.

According to an example embodiment of the sixth aspect, the extraction of the data from the resource elements of the data channel and the de-scrambling of the data may be dependent on a subset of bits for the frame number of the transmission frame.

According to an example embodiment of the sixth aspect, the subset of bits may comprise third and second least significant bits for the frame number.

According to an example embodiment of the sixth aspect, the extraction of the data from the resource elements of the data channel may comprise de-interleaving the data based on an interleaving pattern, wherein the interleaving pattern is dependent on the frame number of the transmission frame.

According to an example embodiment of the sixth aspect, the method may further comprise: decoding the data with a channel decoder; and deinterleaving the data with a de-interleaver of the channel decoder.

According to an example embodiment of the sixth aspect, the channel decoder may comprise a polar decoder.

According to an example embodiment of the sixth aspect, allocation of the data to the resource elements of the data channel may dependent on the frame number of the transmission frame for a plurality of consecutive transmissions of the synchronization signal block, and the method may further comprise: decoding the data from the plurality of consecutive transmissions of the synchronization signal block, wherein parameters of the channel decoder are fixed over the plurality of consecutive transmissions of the synchronization signal block; and combining the data decoded from the plurality of consecutive transmissions of the synchronization signal blocks.

According to an example embodiment of the sixth aspect, the extraction of the data from the resource elements of the data channel may comprise de-mapping the data from the resource elements of the data channel based on a resource element mapping pattern, wherein the resource element mapping pattern is dependent on the frame number of the transmission frame.

According to an example embodiment of the sixth aspect, the resource element mapping pattern may comprise resource elements or blocks of resource elements of the data channel cyclically shifted based on the frame number of the transmission frame.

According to an example embodiment of the sixth aspect, a number of the blocks of resource elements may be higher or equal to a number of combinations of the subset of bits for the frame number of the transmission frame.

According to an example embodiment of the sixth aspect, a subset of the resource elements of the data channel may overlap with the at least one synchronization signal in frequency, and resource element mapping patterns associated with different frame numbers may cause different data to be carried on the subset of the resource elements of the data channel overlapping with the at least one synchronization signal in frequency.

According to an example embodiment of the sixth aspect, the synchronization signal block may comprise: a first orthogonal frequency division multiplexing (OFDM) symbol comprising a primary synchronization signal on a subset of a plurality of subcarriers; a second OFDM symbol comprising resource elements of the data channel at the plurality of subcarriers; a third ODFM symbol comprising a secondary synchronization signal on the subset of the plurality of subcarriers and resource elements of the data channel at edges of the plurality of subcarriers; and a fourth OFDM symbol comprising resource elements of the data channel at the plurality of subcarriers.

According to an example embodiment of the sixth aspect, the method may further comprise: jointly decoding the data based on a plurality of the synchronization signal blocks.

According to a seventh aspect, a computer program, a computer program product, a non-transitory computer readable medium, or a machine readable medium may comprise instructions or program instructions for causing an apparatus to perform at least the following: receiving a synchronization signal block of a transmission frame, wherein the synchronization signal block comprises a data channel; extracting data from resource elements of the data channel, wherein the extraction of the data from the resource elements of the data channel is dependent on a frame number of the transmission frame; and decoding the data. The computer program may further comprise instructions for causing the apparatus to perform any example embodiment of the method of the sixth aspect.

According to an eighth aspect, an apparatus may comprise means for receiving a synchronization signal block of a transmission frame, wherein the synchronization signal block comprises a data channel; means for extracting data from resource elements of the data channel, wherein the extraction of the data from the resource elements of the data channel is dependent on a frame number of the transmission frame; and means for decoding the data. The apparatus may further comprise means for performing any example embodiment of the method of the sixth aspect.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a communication network, according to an example embodiment;

FIG. 2 illustrates an example of a synchronization signal block, according to an example embodiment;

FIG. 3 illustrates an example of an apparatus configured to practice one or more example embodiments;

FIG. 4 illustrates an example of a physical broadcast channel (PBCH) transport, according to an example embodiment;

FIG. 5 illustrates an example of physical broadcast channel (PBCH) payload generation, according to an example embodiment;

FIG. 6 illustrates an example of a first scrambling operation, according to an example embodiment;

FIG. 7 illustrates an example of cyclic redundancy check (CRC) attachment, according to an example embodiment;

FIG. 8 illustrates an example of channel coding, according to an example embodiment;

FIG. 9 illustrates an example of a second scrambling operation, according to an example embodiment;

FIG. 10 illustrates an example of puncturing a physical layer broadcast (PBCH) channel, according to an example embodiment;

FIG. 11 illustrates an example of interleaving pattern, which is dependent on a frame number, according to an example embodiment;

FIG. 12 illustrates an example of a first interleaving pattern of four interleaving patterns applicable for four successive synchronization signal blocks, according to an example embodiment;

FIG. 13 illustrates an example of a second interleaving pattern of four interleaving patterns applicable for four successive synchronization signal blocks, according to an example embodiment;

FIG. 14 illustrates an example of a third interleaving pattern of four interleaving patterns applicable for four successive synchronization signal blocks, according to an example embodiment;

FIG. 15 illustrates an example of a fourth interleaving pattern of four interleaving patterns applicable for four successive synchronization signal blocks, according to an example embodiment;

FIG. 16 illustrates an example of resource allocation for four blocks of resource elements for four successive synchronization signal blocks, according to an example embodiment;

FIG. 17 illustrates an example of resource allocation for four successive synchronization signal blocks at resource block level, according to an example embodiment;

FIG. 18 illustrates an example of resource allocation for five blocks of resource elements for four successive synchronization signal blocks, according to an example embodiment;

FIG. 19 illustrates an example of resource allocation that ensures overlapping of each resource block with synchronization signals, according to an example embodiment;

FIG. 20 illustrates an example of a method for puncturing a synchronization signal block, according to an example embodiment; and

FIG. 21 illustrates an example of a method for receiving a punctured synchronization signal block, according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Example embodiments of the present disclosure may relate to transmission and reception of narrowband communication signals, for example in cellular communication networks such as for example specified by the 3^{rd} generation partnership project (3GPP). An example an suitable system for applying the example embodiments is Narrowband 3GPP 5G New Radio (NB NR), which may be for example targeted for supporting future railway communication needs, smart grid operators, and public safety applications. For example, the example embodiments may be applied to 3GPP work item document(s) (WID) currently being drafted for NR support for dedicated spectrum less than 5 MHz. Narrowband NR (NBNR) may be therefore also referred to as “NR support for dedicated spectrum less than 5 MHz”.

For various reasons, such as for example coexistence with earlier communication systems, it may be desired to transmit signals at a bandwidth that is narrower than intended when designing the signal. One motivation behind this is that, instead of redesign the signal structure, one goal might be to minimize the changes to the existing implementation. One approach for narrowing bandwidth of a signal is to cut out part of the frequency spectrum of the signal. For example, in case of orthogonal frequency division multiplexing (OFDM) based systems, this may be implemented by puncturing (e.g. not transmitting or removing before transmission) subcarriers at edge(s) of the OFDM symbols. Puncturing the signal will however result in loss of information and therefore decoding the signal at a receiver may be harder and therefore means for mitigating the impact of puncturing are considered in this application.

For example, the Future Railway Mobile Communication System (FRMCS) in Europe may use NR with 2×5.6 MHz frequency domain duplex (FDD) channels, for example at 874.4-880 MHz and 919.4-925 MHz. Soft migration from the earlier system GSM-R (global system for mobile Communications—railway) requires parallel operation of GSM-R and NR, which may be expected to last approximately ten years (e.g. from 2025 to 2035). Considering the design of GSM-R, approximately 3.6 MHz may be available for NR, depending on the number of parallel GSM-R channels. Simultaneous deployment of NR and GSM-R may include the following: adjacent channel deployment, where the GSM-R and NR signals are allocated non-overlapping adjacent frequency bands; overlay deployment with compact GSM-R channel placement, where GSM-R and NR signal are partially overlapping in frequency (e.g. with initial access functions of NR) and where GSM-R signals are allocated within a relatively narrow bandwidth; overlay deployment with GSM-R channels distributed over the 4 or 5 MHz core band of NR; and overlay deployment with GSM-R channels distributed over the full ER-GSM band.

However, the adjacent channel deployment and the overlay deployment with compact GSM-R channel placement may be preferred since they may enable easier implementation of NR scheduler and have only one boundary between the NR and GSM-R, thereby providing simpler and more predictable coexistence. In addition to the railway scenario, NB NR may be applied for example for smart grid, for example with 2×3 MHz FDD channels at 900 MHz frequency range in US, or for public safety applications with 2×3 MHz FDD channels in band 29 for PPDR (public protection and disaster release) in Europe. Further application scenarios may include machine type communication, smart phone communication with special bandwidth scenarios, or the like.

According to an example embodiment, an apparatus may obtain data for transmission on a data channel of a synchronization signal block of a transmission frame and allocate the data to resource elements of the data channel. The allocation of the data may be dependent on the frame number of the transmission frame. The apparatus may further puncture one or more resource elements at edge(s) of the synchronization signal block and transmit the synchronization signal block. Another apparatus may receive the synchronization signal block and decode the data. The diversity of the data channel is thereby improved, which enables to reduce degradation of decoding performance caused by the puncturing.

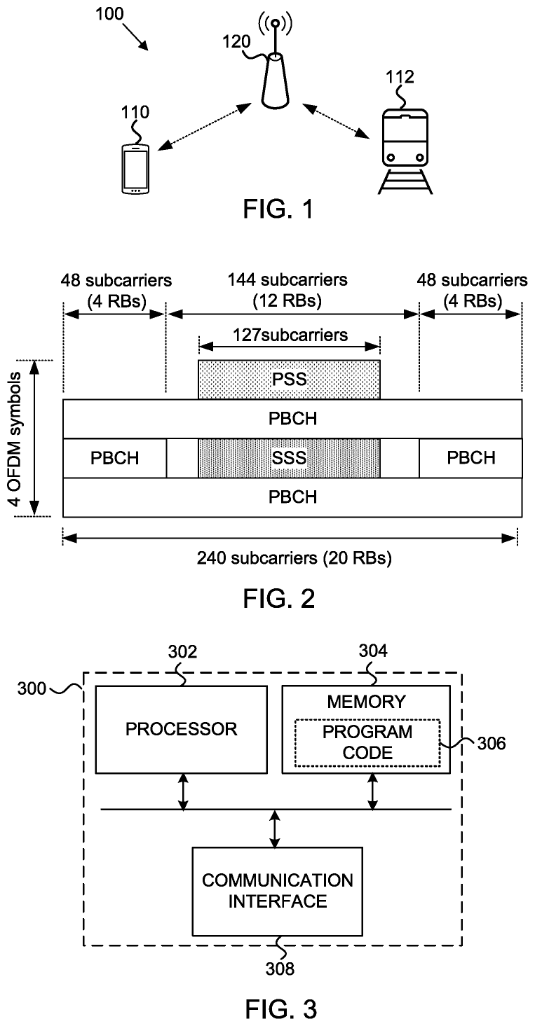

FIG. 1 illustrates an example of a communication network, according to an example embodiment. The communication network 100 may comprise at least one base station 120 and at least one device. A device may be also referred to as a user node, a user device, a client node, or user equipment (UE). A UE 110 may communicate with the base station 120 over wireless radio channel(s). Similarly, train 112, or a subsystem thereof, may communicate with the base station 120. Communications between the UE 110 (or the train 112) and the base station 120 may be bidirectional. Any of these network nodes may be therefore configured to operate as a transmitter and/or a receiver. Even though some example embodiments have been described using the UE 110 as an example, it is appreciated that similar operations may be performed at various type of devices, such as for example a smart phone, a train equipped with an NR device, a car equipped with an NR device, a subsystem of a smart grid, or the like.

The base station 120 may be configured to communicate with network functions or network devices of a core network to provide communication services for the UE 110. Base stations may be also called radio access network nodes and they may be part of a radio access network (RAN) between the core network and the UE 110. The communication network 100 may be configured for example according to, or based on, NR specifications. The base station 120 may therefore comprise a 5^{th} generation base station (gNB). It is however appreciated that example embodiments presented herein are not limited to devices configured to operate under this example network and the example embodiments may be applied in other type of devices, for example devices configured to operate in any present or future wireless or wired communication networks, or combinations thereof, for example other type of cellular networks, short-range wireless networks, broadcast or multicast networks, or the like. Functionality of the base station 120 may be distributed between a central unit (CU), for example a gNB-CU, and one or more distributed units (DU), for example gNB-DUs. Radio access network elements such as gNB, gNB-CU, or gNB-DU may be generally referred to as network nodes or network devices. Although depicted as a single device, a network node may not be a stand-alone device, but for example a distributed computing system coupled to a remote radio head. For example, a cloud radio access network (cRAN) may be applied to split control of wireless functions to optimize performance and cost.

FIG. 2 illustrates an example of a synchronization signal block, according to an example embodiment. A synchronization signal block (SSB) may comprise symbols, for example OFDM symbols, comprising synchronization signal(s) (SS) targeted for performing synchronization (e.g. time, frequency, and/or frame synchronization) at a receiver, for example the UE 110. A SSB may comprise at least one synchronization signal. The SSB may further carry a data channel. For example a portion of the available subcarriers of the OFDM symbol may be configured for carrying a data channel. Such data channel may comprise any suitable data, for example physical layer signaling information. The physical layer may be configured to handle operations similar to as described in the open systems interconnection (OSI) model or a physical layer specification of a particular standard. An OFDM symbol may comprise a plurality of subcarriers. A modulated subcarrier of an OFDM symbol may be referred to as a resource element (RE). A resource block may comprise a block of subcarriers, for example a block of twelve consecutive subcarriers. A resource block may be also referred to as a physical resource block (PRB). A synchronization signal block may comprise a synchronization signal and physical broadcast channel (SS/PBCH) block.

In the example of FIG. 2, the SSB comprises a primary synchronization signal (PSS) and a secondary synchronization signal (SSS). The PSS and SSS may comprise subcarriers modulated with respective sequences of symbols. The SSB may further comprise resource blocks allocated for a physical layer broadcast channel (PBCH). The SSB may include downlink demodulation reference signals (DM-RS) for PBCH as well as PBCH payload data, for example the master information block (MIB). The MIB may comprise signalling data indicative of system information related to, for example, the frequency position (e.g. SSB frequency domain allocation related to a common resource block (CRB) grid) and timing of the SSB (e.g. half frame timing and frame timing). This signalling information may be contained for example in higher layer payload data (e.g. MIB), as a part of the physical layer bits in the transport block payload, or in DM-RS.

PSS and SSS enable downlink frame synchronization and may inform the UE 110 about the physical cell identifier (ID). Downlink transmission may be organized in frames of 10 ms. Based on reception of PSS and SSS, the UE 110 may obtain information about transmission slot timing within the 5 ms half frame. The UE 110 may then determine resource elements for the downlink modulation reference signals (DM-RS) and data to receive the PBCH payload (e.g. MIB).

The PSS may occupy a set of subcarriers of a first OFDM symbol, in this example 127 subcarriers. The PSS subcarriers may be located in the middle of the SSB block in frequency direction. A second OFDM symbol may comprise a set of subcarriers allocated for the PBCH channel. The second OFDM symbols may further comprise DM-RS for PBCH, in this example a set of 240 subcarriers (20 RBs). This set of subcarriers may comprise a continuous set of subcarriers. The set of subcarriers may be partially overlapping in frequency domain with the set of PSS subcarriers. In general, a set may comprise one or more members of the set.

A third OFDM symbol may comprise the SSS. The SSS may occupy a set of subcarriers of the third OFDM symbol, for example the same subcarriers as the PSS in the first OFDM symbol. At edges of the third OFDM symbol, or in general at one or both sides of the SSS, there may be set(s) of subcarriers (e.g. 48 subcarriers/4 RBs) allocated for the PBCH. The third OFDM symbol may further comprise DM-RS for PBCH. Between the two PBCH blocks of the second OFDM symbol, there may be a set of 144 subcarriers (12 RBs), including the 127 subcarriers of the SSS. Between the SSS and the PBCH block(s), there may be hence set(s) of unoccupied subcarriers, in this example 17 subcarriers. A fourth OFDM symbol may comprise a set of subcarriers allocated for the PBCH. The fourth OFDM symbol may further comprise DM-RS for PBCH, similar to the second OFDM symbol. The first, second, third, and fourth OFDM symbols may be first, second, third, and fourth OFDM symbols in transmission order. They may be however indexed at any suitable manner, for example from 0 to 3, respectively. With 15 kHz subcarrier spacing, the PSS and SSS may occupy 2.16 MHz from the middle of the band. The PBCH blocks of the second and fourth OFDM symbols may occupy a 3.6 MHz band. Each PBCH block of the third OFDM symbol may occupy a 0.72 MHz band.

Even though a particular structure of the SSB is illustrated in FIG. 2, it is appreciated that format of the SSB may vary in different implementations. For example, the number and order of the symbols may vary. The example embodiments described herein may be therefore applied to various type of synchronization signal blocks comprising both synchronization signal(s) and one or more data channels. In general, an SSB may comprise symbols, where each of the symbols may comprise resource elements. At least one of the symbols may comprise a synchronization signal on a subset of the resource elements, for example at the middle of the frequency band, as illustrated in FIG. 2. The symbols may further comprise resource elements of a data channel (e.g. PBCH). In one example embodiment, the SSB may comprise a first OFDM symbol, which may comprise a first synchronization signal (e.g. PSS) on a subset of subcarriers of the SSB. The SSB may further comprise a second OFDM symbol, which may comprise REs of a data channel (e.g. PBCH) at the subcarriers, i.e., not only the subset of subcarrier occupied by the first synchronization signal in the first OFDM symbol. The SSB may further comprise a third ODFM symbol, which may comprise a second synchronization signal (e.g. SSS) on a subset of subcarriers. The subset of subcarriers may be the same subset, which is occupied by the first synchronization signal in the first OFDM symbol. The third OFDM symbol may further comprise REs of the data channel at edge(s) of its subcarriers, e.g. both sides of the second synchronization signal. The SSB may further comprise a fourth OFDM symbol comprising REs of the data channel at its subcarriers. The SSB may be however embodied in various formats, for example comprising any two or more of the first to fourth OFDM symbols, where at least one of the OFDM symbols carries a synchronization signal.

In case of punctured transmission of the SSB, some of the resource elements of the data channel may not be transmitted. For example, the punctured resource elements may be removed before transmission. However, channel coding enables the UE 110 to correctly decode the data even if some of the data is missing. Example embodiments of the present disclosure improve decoding the punctured data. Puncturing the data may be applied to narrow down the SSB bandwidth to match the available bandwidth. With the disclosed methods the PBCH data symbols may be more equally shared on the punctured and non-punctured transmission resources among the PBCH transmissions, for example within a 80 ms period of four SSBs, while maintaining the same amount of blind detection hypotheses.

FIG. 3 illustrates an example embodiment of an apparatus 300, for example the base station 120 or the UE 110. The apparatus 300 may comprise at least one processor 302. The at least one processor 302 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware (HW) accelerator, a special-purpose computer chip, or the like.

The apparatus 300 may further comprise at least one memory 304. The at least one memory 304 may be configured to store, for example, computer program code or the like, for example operating system software and application software. The at least one memory 304 may comprise one or more volatile memory devices, one or more non-volatile memory devices, and/or a combination thereof. For example, the at least one memory 304 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 300 may further comprise a communication interface 308 configured to enable apparatus 300 to transmit and/or receive information to/from other devices. In one example, apparatus 300 may use communication interface 308 to transmit and/or receive signals, control messages, or the like. The communication interface may be configured to provide at least one wireless radio connection, such as for example a 3GPP mobile broadband connection (e.g. 3G, 4G, 5G, 6G). However, the communication interface 308 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 308 may comprise, or be configured to be coupled to, circuitry for performing necessary functions for transmitting and/or receiving signals, for example RF circuitry, modulation circuitry, demodulation circuitry, encoder circuitry, and/or decoder circuitry. The communication interface 308 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

The apparatus 300 may further comprise a user interface (not shown) comprising an input device and/or an output device. The input device may take various forms such a keyboard, a touch screen, or one or more embedded control buttons. The output device may for example comprise a display, a speaker, a vibration motor, or the like. User inputs on the user interface may be configured to cause data transmission and/or reception via the communication interface 310.

When the apparatus 300 is configured to implement some functionality, some component and/or components of the apparatus 300, such as for example the at least one processor 302 and/or the at least one memory 304, may be configured to implement this functionality. Furthermore, when the at least one processor 302 is configured to implement some functionality, this functionality may be implemented using the program code 306 comprised, for example, in the at least one memory 304. Furthermore, a computer program product, a non-transitory computer readable medium, or a machine readable medium comprising (program) instruction may be configured to, when executed, cause performance of the apparatus 300.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 300 comprises means for performing at least one example embodiment described herein. In one example, the means comprises the at least one processor 302, the at least one memory 304 including program code 306 configured to, when executed by the at least one processor, cause the apparatus 300 to perform the example embodiment(s). The means may further comprise transmission and/or reception means, such as for example circuitry described with reference to communication interface 308.

The apparatus 300 may comprise for example a computing device such as for example a base station, a server, a network device, a wireless router, a mobile phone, a smart phone, a tablet computer, a laptop, a robot, an internet of things (IoT) device, or the like. Examples of IoT devices include, but are not limited to, consumer electronics, wearables, sensors, and smart home appliances. In one example, the apparatus 300 may comprise a vehicle such as for example a train or a car, or a subsystem or component thereof. Although apparatus 300 is illustrated as a single device it is appreciated that, wherever applicable, functions of the apparatus 300 may be distributed to a plurality of devices, for example to implement example embodiments as a cloud computing service.

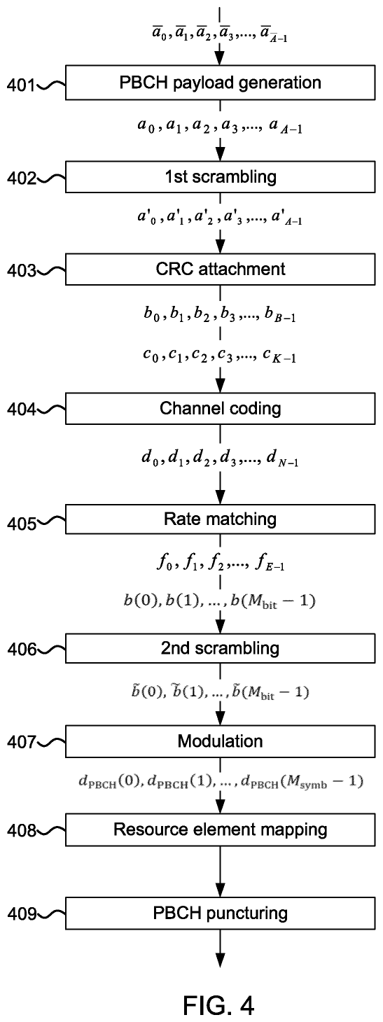

FIG. 4 illustrates an example of a physical broadcast channel (PBCH) transport, according to an example embodiment. The PBCH transport process may have nine different operations, as illustrated in FIG. 4. However, in some embodiments all of the operations may not be present. The PBCH transport process may receive as input a set of bits ā₀, ā₁, ā₂, ā₃, . . . , ā_{Ā-1} corresponding to a transport block, where Ā is the size of payload data of upper transmission layers, The input data may for example comprise 24 bits of BCH (broadcast channel) data. The PBCH transport process may be carried out by the base station 120. However, similar process may be in general performed by any type of transmitter.

At operation 401, the base station 120 may generate the PBCH payload based on the input data. The base station 120 may obtain data for transmission on the PBCH of an SSB of a transmission frame. Even though example embodiments have been described with reference to PBCH, it is understood that the example embodiments may be applied to any type of data channels carried within a synchronization signal block.

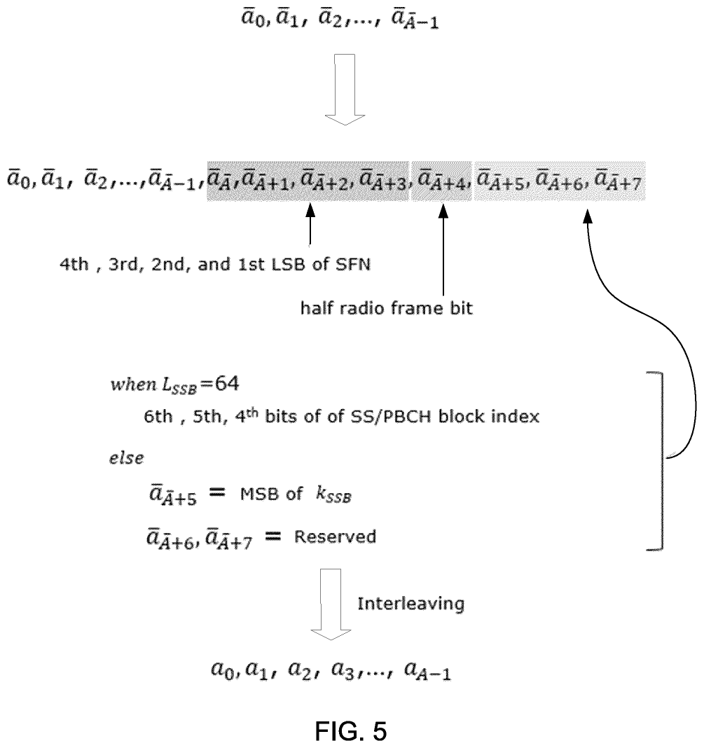

An example of PBCH payload generation is provided in FIG. 5. PBCH payload generation may comprise appending additional timing related bits (e.g. 8 bits) to generate PBCH payload bits (e.g. 32-bits in total). The appended bits are shaded in FIG. 2. For example, a set of bits (ā_{Ā}, ā_{Ā+1}, ā_{Ā+2}, ā_{Ā+3}) may be added to indicate a frame number, for example a system frame number (SFN) of the current transmission frame. These bits may for example comprise four least significant bits (LSB) of the frame number. Furthermore, a half radio frame bit (ā_{Ā+4}) may be added. The rest of the appended bits may be defined as follows: when L_{SSB}=64, the remaining bits (ā_{Ā+5}, ā_{Ā+6}, ā_{Ā+7}) may comprise bits of SS/PBCH block index, for example 6^{th}, 5^{th}, and 4^{th} bits of the SS/PBCH block index. Parameter L_{SSB} may indicate the maximum number of SS/PBCH blocks in an SS/PBCH period for a particular band. Otherwise, one of the remaining bits (bit ā_{Ā+5}) may be set to MSB of k_{SSB} and the other two remaining bits (ā_{Ā+6}, ā_{Ā+7}) may be reserved. Parameter k_{SSB} may indicate a subcarrier offset from subcarrier 0 in a common resource block N_{CRB}^{SSB} to subcarrier 0 of the SS/PBCH block. After appending the bits, the resulting bit sequence may be interleaved to obtain a bit sequence a₀, a₁, a₂, a₃, . . . , a_{A-1}.

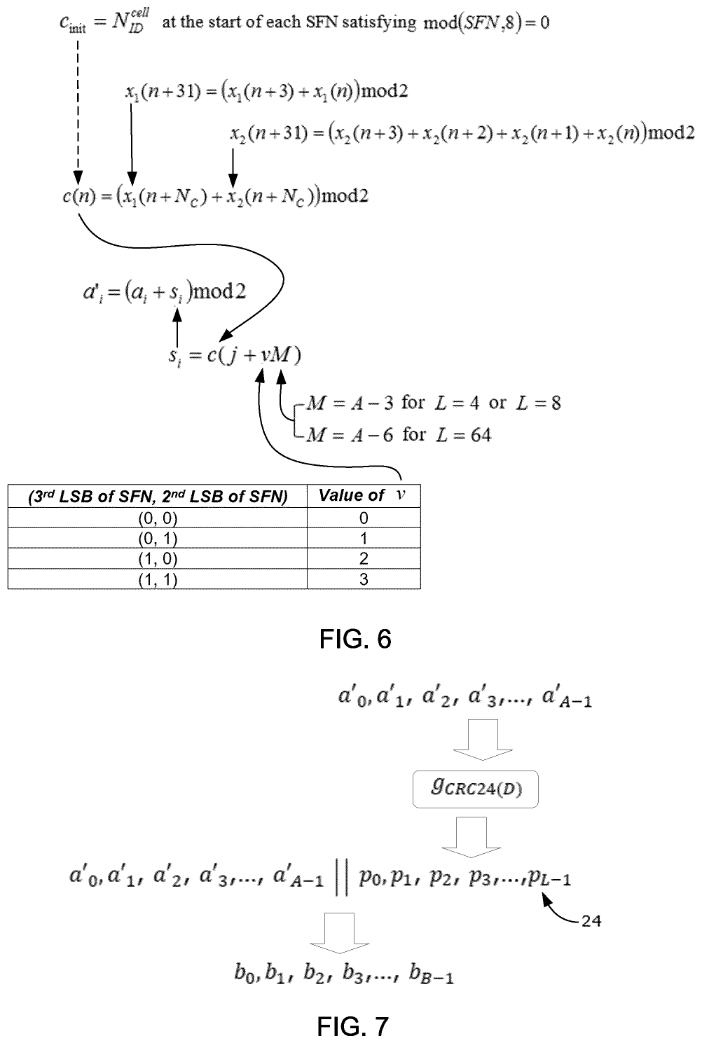

At operation 402, the appended sequence a₀, a₁, a₂, a₃, . . . , a_{A-1} may be scrambled. An example of this first scrambling operation is illustrated in FIG. 6. The type of scrambling may be dependent on the current frame number (e.g. SFN). For example, a value of parameter v may be determined based on the SFN, as defined in the following table, and the first scrambling operation may be dependent on the value of v.

| (3^{rd} LSB of SFN, 2^{nd} LSB of SFN) | Value of v |
|---|---|
| (0, 0) | 0 |
| (0, 1) | 1 |
| (1, 0) | 2 |
| (1, 1) | 3 |

For PBCH transmission in a frame, the bit sequence a₀, a₁, a₂, a₃, . . . , a_{A-1} may be scrambled to obtain a scrambled bit sequence a′₀, a′₁, a′₂, a′₃, . . . , a′_{A-1}, where a′ᵢ=(aᵢ+sᵢ) mod 2. However, any of the bits belonging to the SS/PBCH block index, the half frame index, or 2^{nd} or 3^{rd} LSBs of the SFN may not be scrambled. The value of sᵢ may be obtained based on sᵢ=c(j+vM), where c(n) is a scrambling sequence and j is a scrambling sequence index initiated at zero and incremented for each scrambled bit. Value of parameter M may be obtained by M=A−3 for L=4 or L=8, or M=A−6 for L=64, where L is the number of SS/PBCH blocks in a half frame and A is the length of the bit sequence to be scrambled.

The scrambling sequence c(n)=(x₁(n+N_{c})+x₂(n+N_{c})) mod 2 may be initialized with cᵢₙᵢₜ=N_{ID}^{cell} (physical layer cell identity), for example at the start of each frame satisfying mod(SFN, 8)=0. Sequences x₁ and x₂ may be pseudorandom sequences, for example m-sequences. N_{c} is an initialization parameter for generation of the pseudorandom sequences. The pseudorandom sequences may be generated based on a Gold sequence. The length of the Gold sequence may be 31. N_{c} may be equal to 1600. Furthermore, x₁(n+31) and x₂(n+31) may be obtained by x₁(n+31)=(x₁(n+3)+x₁(n))mod 2 and x₂(n+31)=(x₂(n+3)+x₂(n+2)+x₂(n+1)+x₂(n)) mod 2, respectively. In general, scrambling may comprise randomizing the data content in a known manner such that the UE 110 is able to reconstruct the original (non-scrambled) data by de-scrambling.

Based on the above it is understood that the scrambling operation may be dependent on the frame number (e.g. SFN), for example a subset (e.g. 3^{rd} and 2^{nd} LSBs) of bits of the frame number. Due to this scrambling step the UE 110 has four different hypotheses when detecting the PBCH, the four hypotheses arising from the four possible values of v. When decoding the PBCH, the UE 110 may therefore decode the PBCH payload data with all the possible values of v and see which value enables correct detection of the data.

This feature may be advantageously used also for enabling different allocation of PBCH data among multiple SSBs. The allocation of the PBCH data to the resource elements of the PBCH may be dependent on the frame number (e.g. SFN) of the current transmission frame. The base station 120 may for example use different interleaving or resource element mapping patterns for different SSBs, as will be further discussed below. This may increase diversity of the PBCH data among the SSBs. When puncturing resource elements of the PBCH at certain subcarriers, the different interleaving or resource element mapping pattern causes different data to be punctured at different SSBs. The UE 110 may then leverage the increased diversity by jointly decoding the PBCH data based on multiple SSBs, for example by applying any suitable diversity combining method for PBCH data extracted from different SSBs. Allocation of the PBCH data may be linked with the scrambling operation such that the frame number defines a pair of resource allocation and scrambling operations. The base station 120 may determine a pair of scrambling and resource allocation schemes based on the frame number of the transmission frame; and scramble the data and allocate the data to the resource elements of the data channel based on the determined pair of scrambling and resource allocation schemes. Similarly, the UE 110 may determine a pair of scrambling and resource allocation schemes based on the frame number and then extract and scramble the data accordingly. Since the resource allocation scheme is dependent on the frame number in a similar way as the first scrambling, no additional blind detection hypotheses will need to be applied at the UE 110. A resource allocation scheme may comprise a particular interleaving pattern or particular resource element mapping pattern. A scrambling scheme may comprise a particular scrambling sequence or applying a scrambling sequence with particular starting index.

At operation 403, the base station 120 may attach a cyclic redundancy check (CRC) code to the scrambled bit sequence a′₀, a′₁, a′₂, a′₃, . . . , a′_{A-1}. An example of CRC attachment is illustrated in FIG. 7. A set of L parity bits p₀, p₁, p₂, p₃, . . . , p_{L-1}, for example 24 parity bits (L=24), may be generated using any suitable method, for example a generator polynomial g_{CRC24C}(D) and attached to the scrambled bit sequence. This may result in a bit sequence b₀, b₁, b₂, b₃, . . . , b_{B-1}, where B=A+L. For example, appending the 24-bit CRC to the PBCH payload may result in 56 bits. The bit sequence b₀, b₁, b₂, b₃, . . . , b_{B-1} may be provided as input bit sequence c₀, c₁, c₂, c₃, . . . , c_{K-1} a channel encoder.

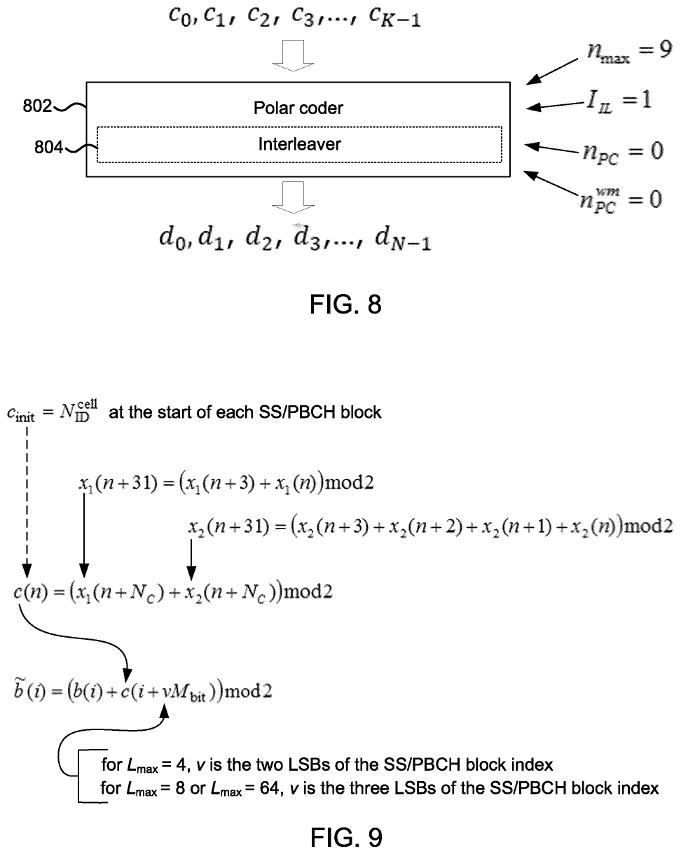

At operation 404, the base station 120 may encode the bit sequence c₀, c₁, c₂, c₃, . . . , c_{K-1}. The base station 120 may use any suitable channel coding method. Channel coding may comprise applying forward error correction (FEC) coding. A channel encoder may add redundant information to the sequence of bits and this may be exploited at the UE 110 for performing error correction. The channel coding may further comprise an interleaving operation. An example of the channel coding operation is illustrated in FIG. 8. In this example, the channel coding is implemented by a polar coder 802. However, any suitable channel encoder may be alternatively used. The polar coder 802 may be configured with nₘₐₓ=9, I_{IL}=1, n_{PC}=0, and n_{PC}^{wm}=0, where nₘₐₓ is the maximum value of n, n being defined as n=2^{N}, I_{IL} indicates whether interleaving is used (I_{IL}=1 indicates interleaving and I_{IL}=0 indicates no interleaving), n_{PC} is the number of parity check bits, and n_{PC}^{wm} is a parity check bit placement parameter of the polar coder 802. The polar coder 802 may comprise an interleaver 804. After the channel coding operation, the output bits may be denoted by d₀, d₁, d₂, d₃, . . . , d_{N-1}, where N is the number of output bits, which may be for example equal to 512.

The interleaver of the channel encoder may be advantageously configured to cause allocation of the PBCH data to the resource elements of the PBCH channel such that the allocation is dependent on the frame number. For example, an interleaving pattern of the interleaver may be dependent on the frame number, as will be further described below. The interleaving pattern, or in general the allocation of the data to the PBCH REs, may be dependent on the frame number for consecutive transmissions of the synchronization signal block. Parameters of the channel encoder (other than the interleaving pattern) may be kept fixed over these consecutive transmissions. For example, the interleaver of the channel encoder may be dependent on v for four consecutive transmissions (v=0, 1, 2, 3), while keeping the channel encoder unchanged. This enables combining the different transmissions at the UE 110.

At operation 405, the base station 120 may perform rate matching. Rate matching may in general comprise adapting the amount of bits to the available transmission resources (PRBs/subcarriers). The output bit sequence after the rate matching operation 405 may be denoted by f₀, f₁, f₂, . . . , f_{E-1}. The length of the rate matching output sequence may be E=864. The output of the rate matching may be provided as input sequence b(0), b(1), . . . , b(M_{bit}−1) to the second scrambling operation 406.

At operation 406, the base station 120 may perform a second scrambling operation. Since the second scrambling 406 is located after the channel coding 404, the second scrambling may involve scrambling of channel coded data, which may include redundancy added by the channel coding. By contrast, the first scrambling 402 may involve scrambling of data prior to channel coding.

The bit sequence b(0), b(1), . . . , b(M_{bit}−1), where M_{bit} is the number of bits transmitted on the PBCH, may be scrambled to obtain a block of scrambled bits \tilde{b}(0), \tilde{b}(1), . . . , \tilde{b}(M_{bit}−1), for example according to \tilde{b}(i)=(b(i)+c(i+vM_{bit}))mod 2. Sequence c(n) may comprise a scrambling sequence, which may be identical to the scrambling sequence of the first scrambling 402. However, the scrambling sequence c(n) may be initiated based on the physical cell identifier of the current cell at the start of each SS/PBCH block (e.g. cᵢₙᵢₜ=N_{ID}^{cell}). Also, the value of may be different from the first scrambling 402. For example, for L̅ₘₐₓ=4, v may be equal to the decimal representation of the two least significant bits of the SS/PBCH block index. For L̅ₘₐₓ=8 or L̅ₘₐₓ=64, v may be equal to the decimal representation of the three least significant bits of the SS/PBCH block index. Parameter L̅ₘₐₓ may indicate a maximum number of SS/PBCH blocks in a half frame.

At operation 407, the base station 120 may modulate the binary sequence \tilde{b}(0), \tilde{b}(1), . . . , \tilde{b}(M_{bit}−1). The modulation operation may comprise mapping groups of bits if the binary sequence to complex-valued modulation symbols, for example quadrature phase shift keying (QPSK) symbols. Modulation may therefore result in a complex number sequence d_{PBCH}(0), d_{PBCH}(1), . . . , d_{PBCH}(M_{symb}−1).

At operation 408, the base station 120 may perform resource element (RE) mapping. The RE mapping may comprise mapping the output data (modulation symbols) of the modulation operation 407 to the REs of the PBCH channel. If QPSK is used, 432 REs may be used to transmit 432 QPSK symbols (864 bits). A SSB may comprise 576 REs dedicated for PBCH. The remaining 144 REs (576-432) may be used for PBCH DM-RS. As described above, in the time domain the SS/PBCH block may comprise four OFDM symbols, which may be numbered in increasing order from 0 to 3 within the SS/PBCH block. PSS, SSS, and PBCH, optionally with associated DM-RS, may be mapped to the OFDM symbols and their subcarriers for example based on the following table:

| | OFDM symbol | |
|---|---|---|
| | number I relative to | |
| Channel or | the start of an | Subcarrier number k relative to |
| signal | SS/PBCH block | the start of an SS/PBCH block |
| PSS | 0 | 56, 57, . . . , 182 |
| SSS | 2 | 56, 57, . . . , 182 |
| Set to 0 | 0 | 0, 1, . . . , 55, 183, 184, . . . , 239 |
| | 2 | 48, 49, . . . , 55, 183, 184, . . . , 191 |
| PBCH | 1, 3 | 0, 1, . . . , 239 |
| | 2 | 0, 1, . . . , 47, |
| | | 192, 193, . . . , 239 |
| DM-RS for | 1, 3 | 0 + 0, 4 + 0, 8 + v, . . . ,236 + v |
| PBCH | 2 | 0 + 0, 4 + 0, 8 + v, . . . ,44 + v |
| | | 192 + v, 196 + v, . . . ,236 + v |

In the frequency domain, an SS/PBCH block may comprise 240 contiguous subcarriers, which may be numbered in increasing order from 0 to 239 within the SS/PBCH block. The quantities k and l may represent the frequency and time indices, respectively, within one SS/PBCH block. The UE 110 may assume that the complex-valued symbols corresponding to resource elements denoted as ‘Set to 0’ in the above table are set to zero. The quantity v in the above table may be given by v=N_{ID}^{cell} mod 4. The quantity v in the above table may be therefore different from the parameter v of the first and second scrambling operations 402 and 406. The quantity k_{SSB} is the subcarrier offset from subcarrier 0 in a common resource block N_{CRB}^{SSB} to subcarrier 0 of the SS/PBCH block. The value of N_{CRB}^{SSB} may be derived based on a higher-layer parameter offsetToPointA. The four least significant bits of k_{SSB} may be given by a higher-layer parameter ssb-SubcarrierOffset and for SS/PBCH block type A the most significant bit of k_{SSB} may be given by ā_{Ā+5} in the PBCH payload. If ssb-SubcarrierOffset is not provided, k_{SSB} may be derived from the frequency difference between the SS/PBCH block and Point A. Point A may comprise a common reference point for resource block grids and it may be determined for example based on the signaling parameter offsetToPointA. Parameter offsetToPointA may indicate the frequency offset between Point A and the lowest subcarrier of the lowest resource block, which overlaps with the SS/PBCH block used by the UE 110 for initial cell selection, expressed for example in units of resource blocks assuming 15 kHz or 60 kHz subcarrier spacing, depending on the frequency range. Symbols d_{PBCH}(0), d_{PBCH}(1), . . . , d_{PBCH}(M_{symb}−1) may mapped to resource elements (k, l)_{p,μ} in increasing order of first the index k and then the index l. Parameter p may denote antenna port and parameter μ may denote a subcarrier spacing configuration. The subcarrier spacing Δf may be determined based on the subcarrier configuration by Δf=2^{μ}·15 [kHz]. M_{symb} may denote the number of the symbols to be mapped to the resource elements.

The resource mapping may be advantageously configured to cause allocation of the PBCH data to the resource elements of the PBCH channel such that the allocation is dependent on the frame number. For example, a resource element mapping pattern may be dependent on the frame number, as will be further described below.

At operation 410, the base station 120 may puncture the PBCH channel. Puncturing the PBCH channel may comprise puncturing (not transmitting) a set of REs (subcarriers) at one edge or both edges of the SSB. The punctured REs may comprise REs allocated for the PBCH data. The punctured REs may also comprise DM-RS for PBCH. The PBCH data that has been allocated to the REs that are available after the puncturing may be transmitted, while PBCH data that has been allocated to the punctured REs may not be transmitted. A portion of the PBCH data obtained for transmission may be therefore transmitted at the PBCH REs available after the puncturing.

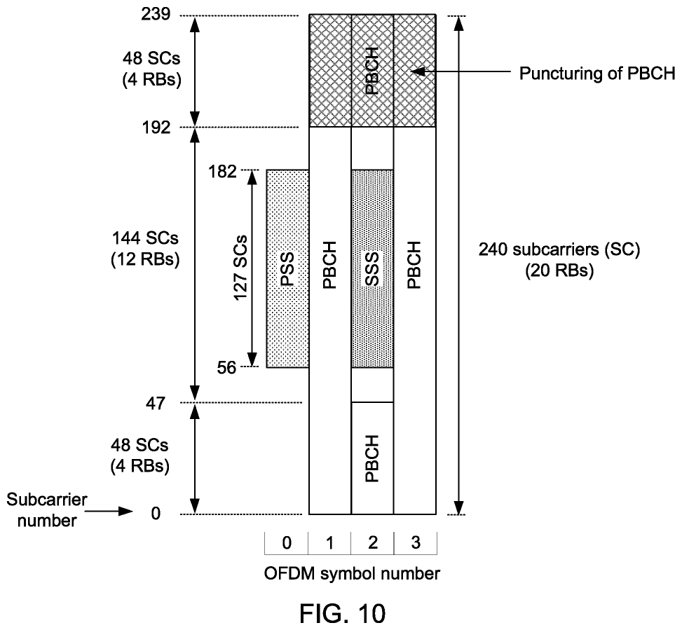

An example of puncturing the PBCH data is provided in FIG. 10. The SSB may comprise four OFDM symbols indexed from 0 to 3 and carrying PSS, SSS, and PBCH data, as already described with reference to FIG. 2. The subcarriers of the SSB may be indexed from 0 to 239. The PSS may occupy 127 subcarriers at indices 56 to 180 of OFDM symbol 0. The SSS may occupy the same subcarriers at OFDM symbol 2. OFDM symbol 2 may further comprise PBCH data at subcarriers 0 to 47 and 192 to 239. OFDM symbols 1 and 3 may comprise PBCH data at subcarriers 0 to 239. A subset of the PBCH data may therefore overlap with the synchronization signals PSS/SSS in frequency. Part of the PBCH data may be therefore transmitted on the same subcarriers as the synchronization signals.

As illustrated in FIG. 10, a set of subcarriers (REs) may be punctured at the edge of the SSB. In this example, four resource blocks are punctured at subcarriers 192 to 239. It is however possible to puncture less resource blocks or resource elements. Is it also possible to puncture subcarriers at both edges of the SSB. Puncturing the subcarriers at the edge(s) of the SSB reduces the bandwidth of the SSB.

At the time of initial access, the UE 110 may not be aware of the actual bandwidth of the PBCH. If the UE 110 operates according to the bandwidth of complete PBCH, the UE 110 may suffer from a significant performance degradation, as shown in the following table for the following simulation case:
one-sided puncturing of PBCH as illustrated in FIG. 10,
additive white Gaussian noise (AWGN) used to mimic GSM-R interference,
base station 120 does not transmit PBCH on the punctured PRBs and the UE performs detection assuming complete (wrong) PBCH transmission bandwidth.
   In the table, degradation on SNR (dSNR) that is required for adequate PBCH detection performance is shown for different amount of RB puncturing (i.e. 2, 4, and 6 RBs). The detection performance for PBCH without any RB puncturing is used as reference for dSNR.

| “GSM” RX | dSNR [dB] with | dSNR [dB] with | dSNR [dB] with |
|---|---|---|---|
| power level | 2 RBs compared | 4 RBs compared | 6 RBs compared |
| [dB] vs. PBCH | to reference | to reference | to reference |
| −100 | 1.2 | 2.9 | 4.2 |
| −10 | 1.2 | 3.1 | 4.3 |
| −6 | 1.3 | 3.3 | 4.7 |
| −3 | 1.4 | 3.7 | 5.6 |
| 0 | 1.6 | 5.3 | 12.5 |

Depending on the interference power, PBCH detection performance may be degraded by more than 5 dB. This would mean that the UE 110 would not be able to access the cell frequently. It is also noted that in deployment scenarios like GSM-R reframing, GSM and NR base stations may be likely co-located to same transmission sites, increasing the probability of higher GSM interference levels.

Even the UE 110 would combine different PBCH transmissions, for example PBCH data of four different SSBs, the performance may not be sufficient if the PBCH data remains the same and the same data symbols are punctured in each PBCH transmission. In other words, PBCH combining would suffer from the same puncturing impact on the different PBCH transmissions. The following table shows the puncturing rate for different numbers of punctured RBs in the case of asymmetric (one-sided) puncturing. In case of symmetric (two-sided) puncturing, when the given number of RBs is punctured from the both sides of PBCH, the puncturing rates would be two times the rates of the asymmetric case.

| | Puncturing rate |
|---|---|
| 1 RB | 6.25% |
| 2 RB | 12.5% |
| 3 RB | 18.75% |
| 4 RB | 25% |

The error rate (e.g. block error rate, BLER) after combining the PBCH transmissions of different SSBs may be improved if the puncturing is spread evenly over all the bits, in contrast to the approach where the same bits are suffering from puncturing in each transmission. Example embodiments of the present disclosure therefore provide mechanisms to cause the puncturing to be applied to different data in different SSBs.

As described above, the base station 120 may allocate the PBCH data to the REs of the PBCH such that the allocation is dependent on the frame number (e.g. SFN). According to an example embodiment, the interleaver 804 of the polar coder 802 may be dependent of the value v. Therefore, four different data interleaver patterns may be defined and the selection of the interleaving pattern may be dependent on v. Different interleaving patterns may be generated by using different starting indices for one base interleaving pattern, or, by defining a number of different interleaving patterns. The starting index or the selection of the interleaving patterns among multiple options may be based on the value of v. Since v may be dependent on the frame number (SFN), the interleaving pattern may be dependent on the frame number, for example a subset of bits of the frame number. The polar coding interleaver 804 may be for example defined as a function of the 3^{rd} and 2^{nd} LSB bits of the frame number. Using a different polar coding interleaver 804 depending on the frame number causes the PBCH data to be allocated dependent on the frame number, which increases diversity of the PBCH transmission and makes it more tolerant to puncturing.

Even though the polar coding interleaver 804 is used as an example, it is understood that interleavers associated with other type of channel encoders, or interleavers not associated with any channel encoder, may be used for the same purpose. It is further noted that since the interleaving depends on the frame number similar to the first scrambling 402, using the v-dependent interleaver does not result in additional blind detection combinations to be tested by the UE 110. This enables to improve the decoding performance without significantly increasing complexity at the UE 110.

The frame number dependent interleaving pattern may be defined by any suitable manner. According to an example embodiment, a starting index m of the interleaving pattern may be determined based on v, or in general based on the frame number, for example as follows:
if v=0→m starts from 0
if v=1→m starts from 41
if v=2→m starts from 82,
if v=3→m starts from 123.

The bit sequence c₀, c₁, c₂, c₃, . . . , c_{K-1} may be then interleaved into bit sequence c′₀, c′₁, c′₂, c′₃, . . . , c′_{K-1} for example as follows:

c′ₖ=c_{Π(k)},k=0,1, . . . ,K−1

where the interleaving pattern Π(k) may be given by the following:

```
if I_{IL} = 0
  Π(k) = k, k = 0,1,...,K − 1
else
  k = 0; m = 41v
  for s = 0 to K_{IL}^{max}−1
    if Π_{IL}^{max}(m) ≥ K_{IL}^{max} − K
      Π(k) = Π_{IL}^{max}(m) − (K_{IL}^{max} − K);
      k = k + 1;
      m = mod(m + 1, K_{IL}^{max});
    end if
  end for
end if
```

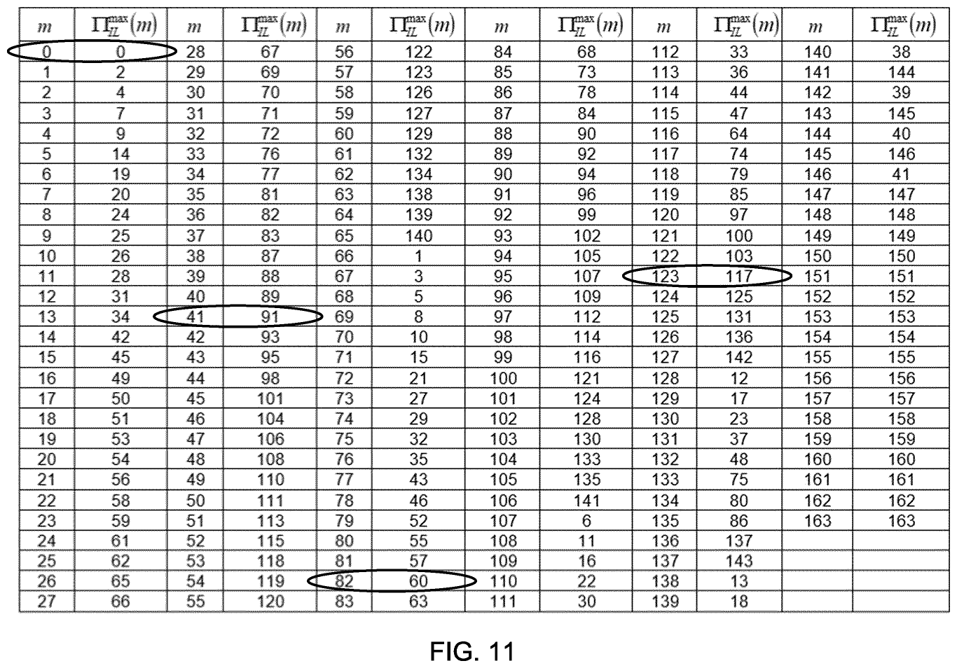

In the above pseudocode, Π_{IL}^{max}(m) defines how the bits are permutated to yield the interleaving pattern Π(k). Π_{IL}^{max}(m) may be given by the table of FIG. 11. Parameter K_{IL}^{max} may be equal to 164. K may refer to the length of the interleaved bit sequence. The interleaving pattern may therefore be dependent on v. Value v may be based on a subset of bits of the frame number, as described above, but in general the value of v may comprise a value derivable from the frame number. The starting index of the interleaving pattern may be determined based on an integer multiple of the value of v, for example by m=41v. Examples of different starting indices resulting in four different interleaving patterns have been circled in FIG. 11.

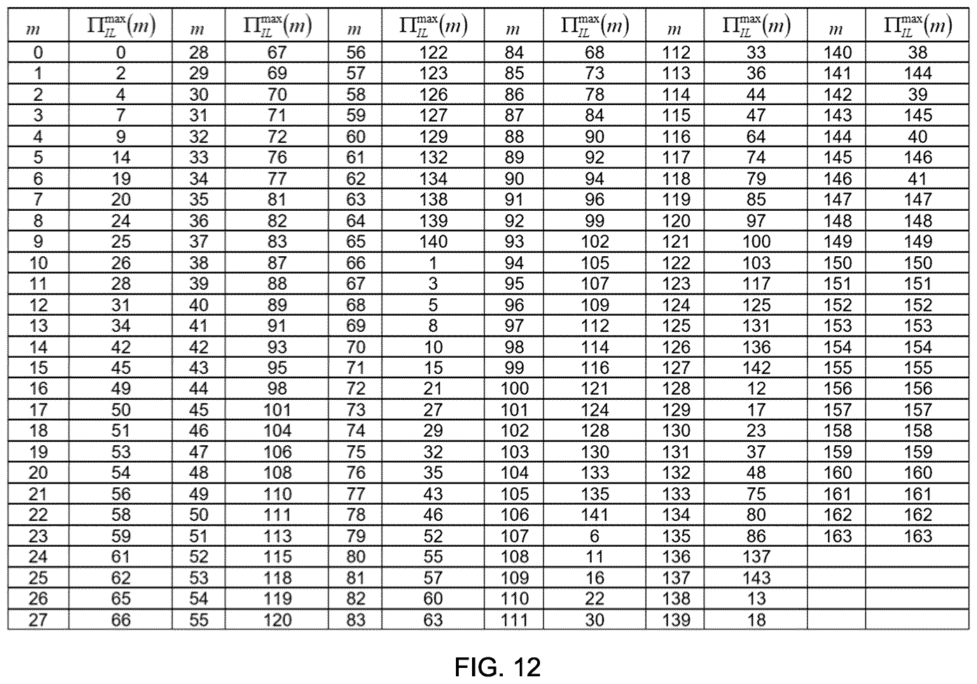

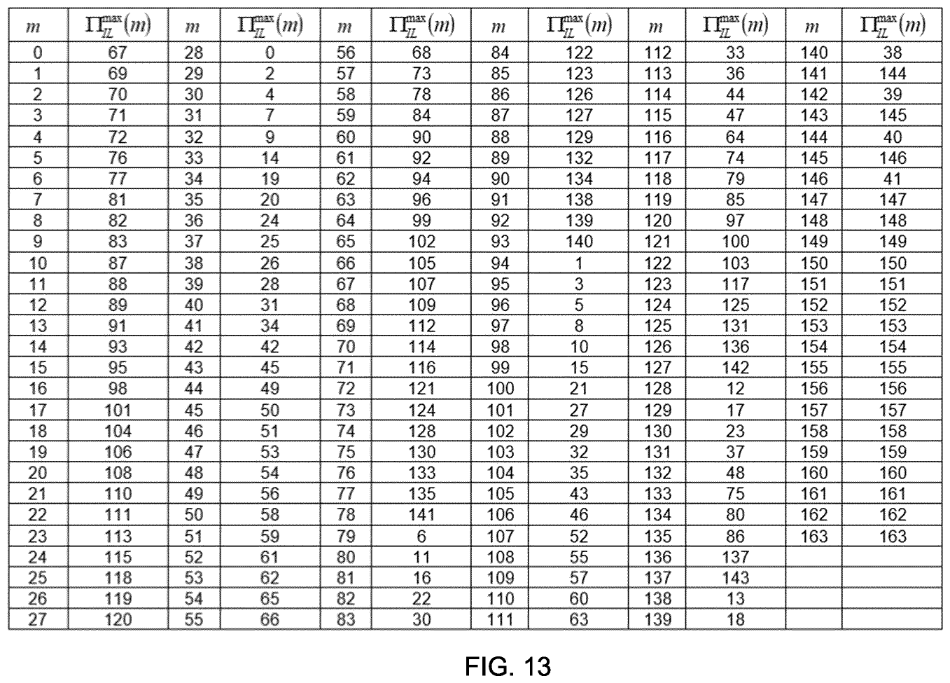

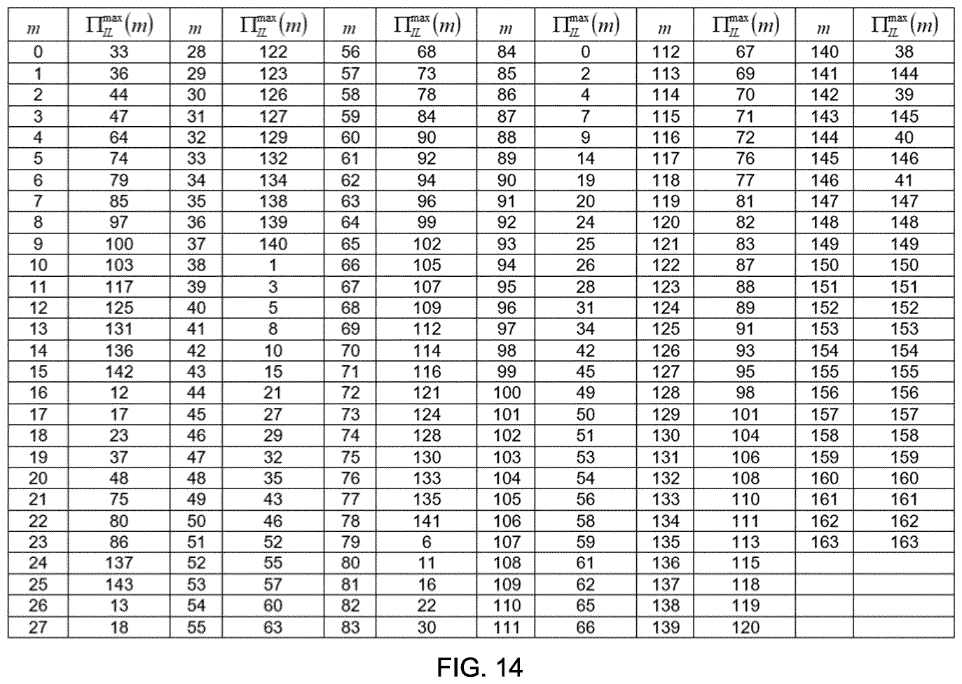

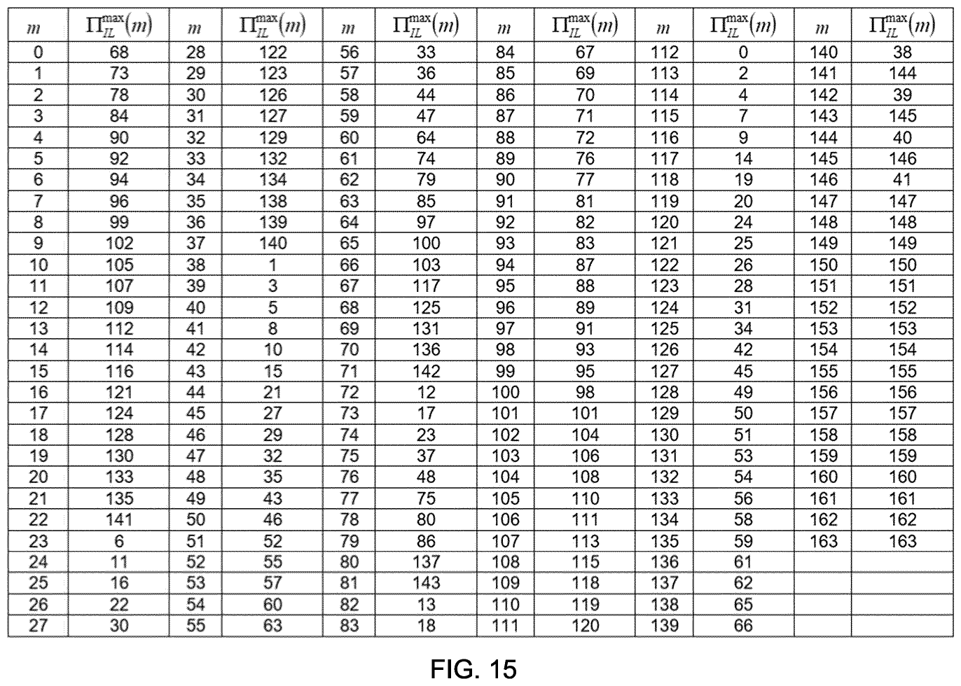

According to an example embodiment, different interleaving patterns may be defined for different values of v. Examples of four different interleaving patterns are illustrated in FIG. 12 to FIG. 15. The interleaving patterns may be configured such that different bits or symbols are punctured in different (four) transmissions. This enables to improve detection performance at the receiver by combining the transmissions. The different interleaving patterns may be associated with different values of v. For example, the table of FIG. 12 may be used for v=0, the table of FIG. 13 may be used for v=1, the table of FIG. 14 may be used for v=2, and the table of FIG. 15 may be used for v=3. Hence, multiple interleaving patterns may be configured at the base station 120 and the UE 110. The interleaving pattern may be selected based on the current value of v, which is dependent on the frame number. One of the interleaving patterns may be configured to be used for normal operation (e.g. normal bandwidth without puncturing), in addition to being one of the multiple interleaving patterns configured for the narrowband (e.g. punctured) operation. This may enable partial backwards compatibility, since one of the PBCH instances may still be received in good channel conditions using the normal interleaving pattern.

According to an example embodiment, the frame number dependent allocation of the PBCH data may be performed based on a frame number dependent resource element mapping pattern, which may be applied at the RE mapping operation 408. An RE mapping pattern may be used to map complex-valued modulation symbols (e.g. QPSK) to the resource elements of the PBCH. The RE mapping of PBCH data symbols may be for example based on four different mapping patterns that are dependent on the value v.

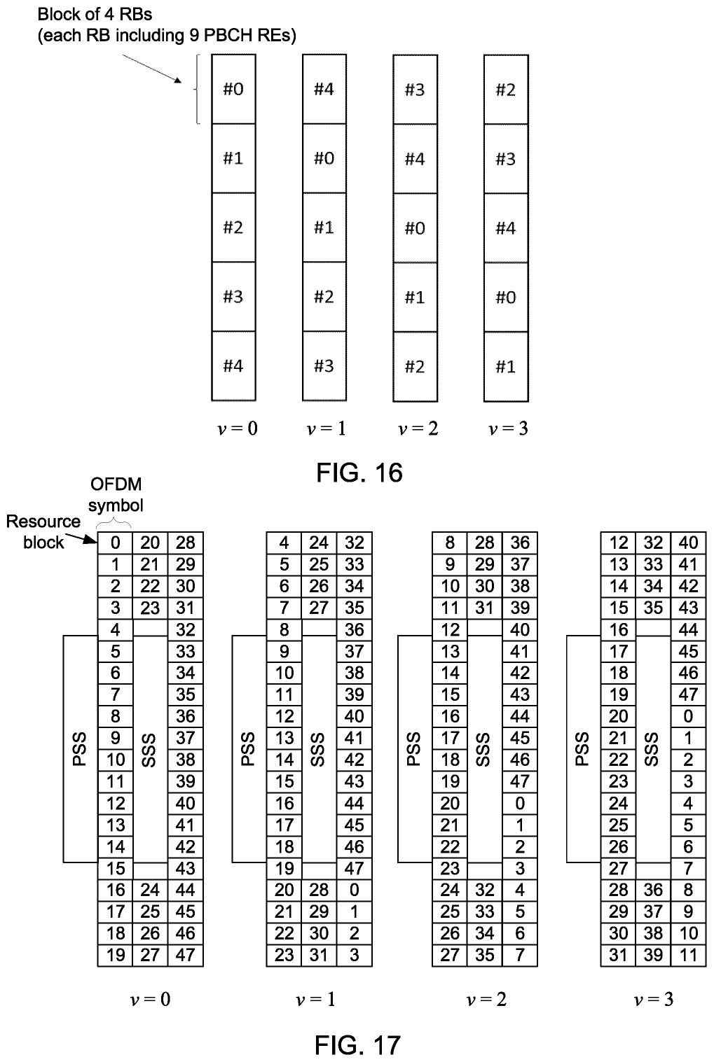

FIG. 16 illustrates an example of a resource element mapping pattern with a cyclic shift. In this example, a cyclic shift of four resource block (RB) is applied for successive values of v. Hence, the RE mapping pattern applied for a particular SSB may comprise RBs or REs that are cyclically shifted based on the frame number. The PBCH RBs of one SSB may be divided into five blocks (#0, #1, #2, #3, #4) of RBs or REs. A RB may comprise PBCH data (e.g. 9 REs) and reference signals (e.g. DM-RS), as further described with reference to FIG. 17. The number of these blocks may be higher than the number of possible values of v, which may be equal to the number of possible combinations of the subset of bits of the frame number. In this example the number of the blocks is five and the number of possible values of v is four. The base station 120 may therefore implemented the v-dependent mapping based on cyclically shifting the RB blocks for the PBCH data symbols. The UE 110 may perform corresponding de-mapping according to the v-hypothesis when decoding.

FIG. 17 illustrates an example of a resource element mapping pattern at resource block level, according to an example embodiment. This figure illustrates the RE mapping pattern resulting from the cyclic shift of FIG. 16. The PBCH RBs have been outlined with square boxes. Each RB may contain twelve REs, each RB carrying nine QPSK symbols of PBCH data on nine REs. In other words, a set of nine consecutive QPSK symbols of PBCH data may be mapped to a RB. Remaining three REs per each RB may carry DM-RS. The sets of nine consecutive QPSK symbols of PBCH data have been numbered from 0 to 47 for illustrative purposes. A first OFDM symbol of the SSB may comprise the PSS, as described above. For v=0, the mapping of the PBCH data may be initiated from the first RB of the second OFDM symbol and continued subcarrier wise through the third and fourth OFDM symbols, skipping the subcarriers not allocated for PBCH data in the third OFDM symbol. For v=1, the RE mapping pattern may be shifted by four RBs. For example, PBCH symbols that would be normally mapped to the fifth RB of the second OFDM symbol (Set 4) may be mapped the first RB of the second OFDM symbol. The mapping may be then continued in the normal order of RBs. However, the QPSK symbol sets skipped at the beginning (Sets 0 to 3) may be mapped at the last RBs of the fourth OFDM symbol. For v=2 and v=3, cyclic shifts of eight and twelve resource blocks may be applied in a similar way.

The mapping of the PBCH data symbols β_{PBCH} to the resource elements a_{k,l}^{(p,μ)} may be implemented for example based on

$${a}_{k , l}^{( p , μ )} = {β}_{PBCH} ( d ( av + m ) mod {M}_{symb} )$$

in increasing order of first the index k (subcarrier) and then the index l (OFDM symbol) for m=0, 1, . . . M_{symb}−1, where α is an offset factor, e.g. α=9*4, and d denotes the complex valued (e.g. QPSK) symbols. With careful inspection of the RE mapping patterns illustrated in FIG. 17, it may be observed that even if four RBs were punctured asymmetrically from one PBCH edge, or, two RBs were punctured symmetrically from both PBCH edges, all 432 QPSK symbols would be transmitted at least twice over the period of 4 SSB transmissions and 360 QPSK symbols out of the 432 symbols (83%) would be transmitted at least three times. Even more even distribution of puncturing over the QPSK symbols may be achieved by defining the offset factor α as a function of v. For example, a mapping between values of α and v may be provided (e.g. α=0 when v=0, α=12 when v=1, α=24 when v=2, and α=36 when v=3. There are however other possibilities to determine the offset factor α, in addition to the simple approach described above. In one example, offset factor α=9*12 may be applied.

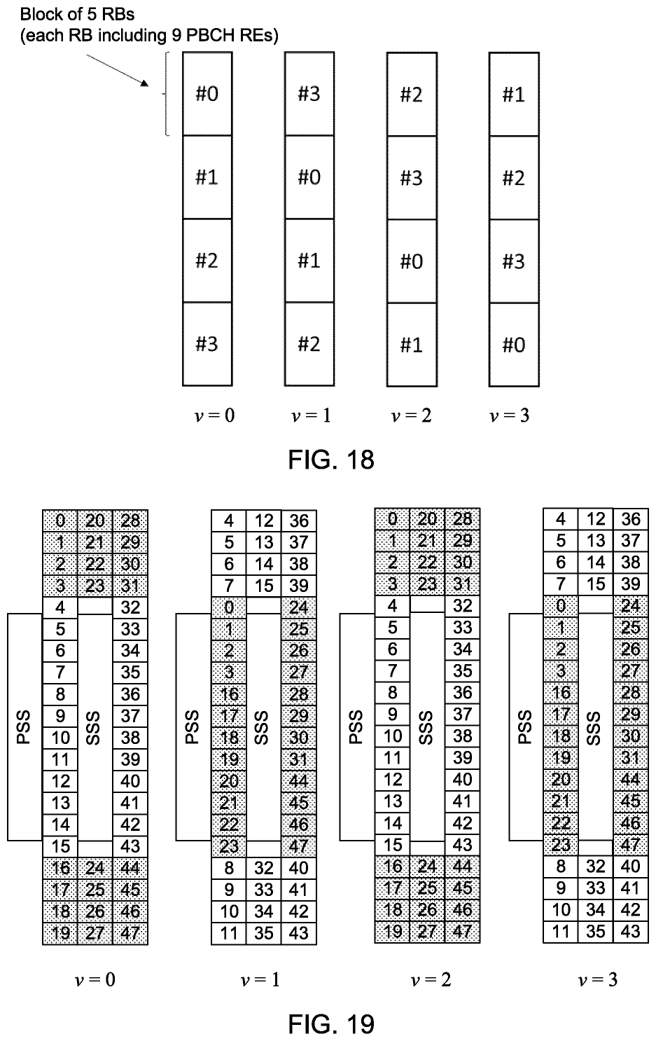

FIG. 18 illustrates another example of a resource element mapping pattern with a cyclic shift, according to an example embodiment. In this example, a cyclic shift or offset of five QPSK symbol sets, corresponding to five RBs, is applied for successive values of v. The PBCH RBs of one SSB may be divided into four blocks (#0, #1, #2, #3) of RBs or REs. The number of the blocks may be therefore equal to the number of possible values of v. In this example, the number of the blocks is four and the number of possible values of v is four. This example embodiment is well-aligned with the four PBCH transmission occasions, for example within the 80 ms period.

FIG. 19 illustrates an example of resource allocation that ensures overlapping in frequency of each set of QPSK symbols of PBCH data with synchronization signals, according to an example embodiment. The RE level resource mapping pattern may be created per v such that PBCH data symbols are allocated as equally as possible upon the REs overlapping with the synchronization signals (PSS/SSS) in frequency over successive PBCH transmissions, for example over the 80 ms period. A benefit provided by this approach is that the PSS and SSS, as well as the overlapping RBs, may not be punctured. An example of such mapping is shown in FIG. 19. In this example, every QPSK symbol is mapped to RBs overlapping with the PSS/SSS twice over the period of four transmission occasions. A subset of the PBCH REs may therefore overlap with synchronization signal(s) of the SSB in frequency. The RE mapping patterns associated with different frame numbers may cause different data to be mapped to this subset of REs.

For example, when v=0 or v=2, the QPSK symbol sets 0 to 3 may be allocated to subcarriers or RBs not overlapping with the PSS or SSS. However, when v=1 or v=3, the QPSK symbol sets 0 to 3 may be allocated to subcarriers overlapping with the PSS or SSS, as illustrated in the figure. The same may apply also for the other QPSK symbol sets 5 to 47. When the UE 110 is decoding the PBCH data, the UE 110 may determine, for each v hypothesis, also a) v-dependent polar code interleaver or b) v-dependent PBCH data symbol mapping pattern. The UE 110 may then perform PBCH decoding based on applying corresponding de-interleaver in option a) or de-mapper in option b).

In general, the UE 110, or in general a receiver, may be configured to perform opposite functionality compared to the base station 120. For example, the UE 110 may receive the punctured SSB(s), extract data from the REs of the PBCH, and decode the data. Extracting the data may comprise de-mapping the data from the REs of the PBCH. This may be done for example based on the above described RE mapping patterns that are dependent on the frame number. Extracting the data based on a frame number dependent RE mapping pattern may comprise applying a blind detection hypothesis on the frame number (or v) and de-mapping the data based on the hypothesis. The UE 110 may therefore extract the data with different assumptions on the frame number and check which RE mapping pattern results in the data being correctly decoded. If the frame number is known, the UE 110 may select the RE mapping pattern based on the frame number and extract the data based on the selected RE mapping pattern. Decoding the data may for example comprise demodulating the data and channel decoding the data. Decoding the data may further comprise de-scrambling the data, for example by a first de-scrambler to compensate for the first scrambling operation 402 at the base station 120. The de-scrambling may be dependent on the frame number, similar to the first scrambling 402. Channel decoding may comprise applying a de-interleaver to restore the order of bits before the interleaving at the channel encoder (e.g. polar encoder 802) at the base station.

The UE 110 may decode data from multiple consecutive transmissions of the SSB. Parameters of the channel decoder (other than the de-interleaving) may be kept fixed over the consecutive transmissions of the SSB. The UE 110 may then combine the data decoded from the consecutive transmissions of the SSB. For example, if the interleaver of the channel encoder, or in general the PBCH RE mapping, is dependent on v for four consecutive transmission (v=0, 1, 2, 3) and the channel encoder is unchanged, the four consecutive transmissions may be combined at the UE 110, when decoding the PBCH data.

The de-interleaving may be based on the frame number dependent interleaving patterns used at the base station 120. De-interleaving the data based on a frame number dependent interleaving pattern may comprise applying a blind detection hypothesis on the frame number (or v) and de-interleaving the data based on the hypothesis. The UE 110 may therefore de-interleave the data with different assumptions on the frame number and check which interleaving pattern results in the data being correctly decoded. If the frame number is known, the UE 110 may select the interleaving pattern based on the frame number and de-interleave the data based on the selected interleaving pattern. Furthermore, as described above, the UE 110 may jointly decode the data based on PBCH data received at multiple SSBs, for example by using any suitable diversity combining method. The different resource allocation of the PBCH data therefore enables to improve decoding performance of the UE 110 in case of punctured PBCH transmission.

Although example embodiments have been described using the SSB (SS/PBCH) structure of NR as an example and using the PBCH repetition defined for NR, the example embodiments may be applied in other scenarios as well. For example, in certain scenarios the PBCH may be repeated more than four times, or less than four times. As another example, the PBCH may be defined separately from synchronization signal(s). Furthermore, the SSB may contain other signals in addition to PSS/SSS and PBCH, for example SSB-specific channel state information reference signals (CSI-RS).

Also, the amount of PBCH puncturing may vary. For example, in some embodiments, the amount of puncturing may be 1, 2, 3, 4, 5, 6, 7, or 8 RBs. The punctured RBs may be also different in different embodiments. For example, the RBs may be punctured asymmetrically (e.g. puncturing from one side only (e.g. 4 RBs), or symmetric (e.g. 3+3 RBs). Puncturing may be also asymmetric, having different amount of punctured RBs at both sides (e.g. 2+3 RBs or 3+2 RBs). The UE 110 may be aware of the punctured RBs when detecting the PBCH. Another option is that the UE 110 tries PBCH detection using multiple hypotheses. When combining multiple PBCH transmission with different frame numbers (allocation of the data to the resource elements of the data channel being dependent on the frame number of the transmission frame), the UE 110 may assume that punctured RBs are the same for the repeated transmissions. Various modifications of the example embodiments may be therefore applied.

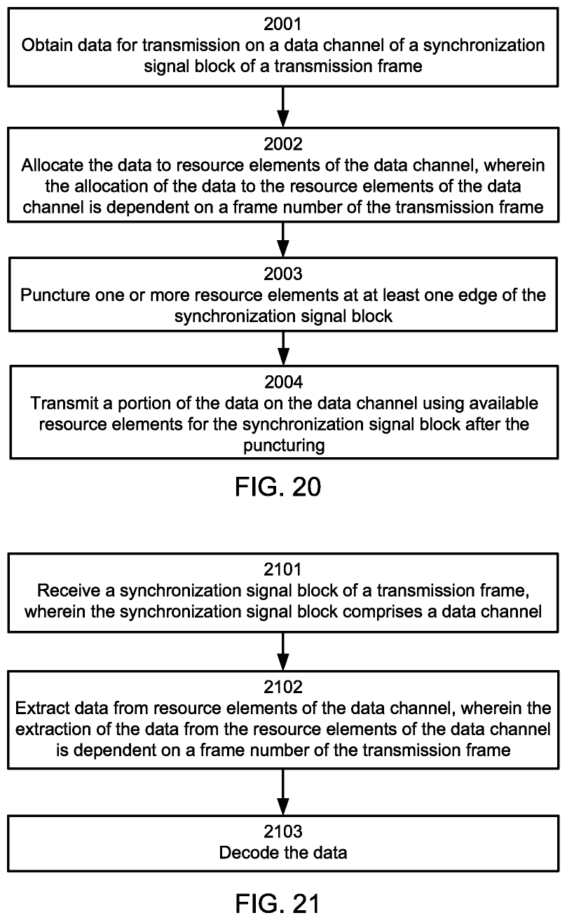

FIG. 20 illustrates an example of a method for puncturing a synchronization signal block, according to an example embodiment.

At operation 2001, the method may comprise obtaining data for transmission on a data channel of a synchronization signal block of a transmission frame.

At operation 2002, the method may comprise allocating the data to resource elements of the data channel, wherein the allocation of the data to the resource elements of the data channel is dependent on a frame number of the transmission frame.

At operation 2003, the method may comprise puncturing one or more resource elements at at least one edge of the synchronization signal block.

At operation 2004, the method may comprise transmitting a portion of the data on the data channel using available resource elements for the synchronization signal block after the puncturing.

FIG. 21 illustrates an example of a method for receiving a punctured synchronization signal block, according to an example embodiment.

At operation 2101, the method may comprise receiving a synchronization signal block of a transmission frame, wherein the synchronization signal block comprises a data channel.

At operation 2102, the method may comprise extracting data from resource elements of the data channel, wherein the extraction of the data from the resource elements of the data channel is dependent on a frame number of the transmission frame.

At operation 2103, the method may comprise decoding the data.

Further features of the methods directly result for example from the functionalities and parameters of the base station 120 and/or the UE 110, as described in the appended claims and throughout the specification, and are therefore not repeated here. Different variations of the methods may be also applied, as described in connection with the various example embodiments.

An apparatus, for example a base station or a UE, may be configured to perform or cause performance of any aspect of the methods described herein. Further, a computer program may comprise instructions for causing, when executed, an apparatus to perform any aspect of the methods described herein. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1-40. (canceled)

41. An apparatus, comprising:
at least one processor; and
at least one memory storing instructions, when executed by the at least one processor, cause the apparatus at least to:
obtain data for transmission on a data channel of a synchronization signal block of a transmission frame;
allocate the data to resource elements of the data channel, wherein the allocation of the data to the resource elements of the data channel is dependent on a frame number of the transmission frame;
puncture one or more resource elements at at least one edge of the synchronization signal block; and
transmit a portion of the data on the data channel using available resource elements for the synchronization signal block after the puncturing.

42. The apparatus according to claim 41, wherein the instructions, when executed by the at least one processor, cause the apparatus to:
determine a pair of scrambling and resource allocation schemes based on the frame number of the transmission frame; and
scramble the data and allocate the data to the resource elements of the data channel based on the determined pair of scrambling and resource allocation schemes.

43. The apparatus according to claim 42, wherein the allocation of the data to the resource elements of the data channel and the scrambling of the data are dependent on a subset of bits for the frame number of the transmission frame.

44. The apparatus according to claim 41, wherein the allocation of the data to the resource elements of the data channel comprises interleaving the data based on an interleaving pattern or mapping the data to the resource elements of the data channel based on a resource element mapping pattern, wherein the interleaving pattern and the resource element mapping pattern are dependent on the frame number of the transmission frame.

45. The apparatus according to claim 44, wherein the allocation of the data to the resource elements of the data channel is dependent on the frame number of the transmission frame for a plurality of consecutive transmissions of the synchronization signal block, and wherein parameters of a channel encoder are fixed over the plurality of consecutive transmissions of the synchronization signal block, wherein the interleaving is performed by an interleaver of the channel encoder.

46. The apparatus according to claim 44, wherein the resource element mapping pattern comprises resource elements or blocks of resource elements of the data channel cyclically shifted based on the frame number of the transmission frame.

47. The apparatus according to claim 46, wherein a number of the blocks of resource elements of the data channel is higher or equal to a number of combinations of a subset of bits for the frame number of the transmission frame.

48. An apparatus, comprising:
at least one processor; and
at least one memory storing instructions, when executed by the at least one processor, cause the apparatus at least to:
receive a synchronization signal block of a transmission frame, wherein the synchronization signal block comprises a data channel;
extract data from resource elements of the data channel, wherein the extraction of the data from the resource elements of the data channel is dependent on a frame number of the transmission frame; and
decode the data.

49. The apparatus according to claim 48, wherein the synchronization signal block comprises a plurality of symbols, each of the plurality of symbols comprising a plurality of resource elements, wherein at least one of the plurality of symbols comprises a synchronization signal on a subset of the plurality of resource elements, and wherein the plurality of symbols comprise the resource elements of the data channel.

50. The apparatus according to claim 48, wherein the instructions, when executed by the at least one processor, cause the apparatus to:
determine a pair of scrambling and resource allocation schemes based on the frame number of the transmission frame; and
de-scramble the data based on the determined pair of scrambling and resource allocation schemes.

51. The apparatus according to claim 50, wherein the extraction of the data from the resource elements of the data channel and the de-scrambling of the data are dependent on a subset of bits for the frame number of the transmission frame.

52. The apparatus according to claim 51, wherein the subset of bits comprises the third and second least significant bits for the frame number.

53. The apparatus according to claim 48, wherein the extraction of the data from the resource elements of the data channel comprises de-interleaving the data based on an interleaving pattern, or de-mapping the data from the resource elements of the data channel based on a resource element mapping pattern, wherein the interleaving pattern and the resource element mapping pattern is dependent on the frame number of the transmission frame.

54. The apparatus according to claim 53, wherein allocation of the data to the resource elements of the data channel is dependent on the frame number of the transmission frame for a plurality of consecutive transmissions of the synchronization signal block, and wherein the instructions, when executed by the at least one processor, cause the apparatus to:
decode the data from the plurality of consecutive transmissions of the synchronization signal block, wherein parameters of a channel decoder are fixed over the plurality of consecutive transmissions of the synchronization signal block, wherein the deinterleaving is performed by a de-interleaver of the channel decoder; and
combine the data decoded from the plurality of consecutive transmissions of the synchronization signal blocks.

55. The apparatus according to claim 53, wherein the resource element mapping pattern comprises resource elements or blocks of resource elements of the data channel cyclically shifted based on the frame number of the transmission frame.

56. The apparatus according to claim 55, wherein a number of the blocks of resource elements is higher or equal to a number of combinations of a subset of bits for the frame number of the transmission frame.

57. The apparatus according to claim 53, wherein a subset of the resource elements of the data channel overlaps with the at least one synchronization signal in frequency, and wherein resource element mapping patterns associated with different frame numbers cause different data to be carried on the subset of the resource elements of the data channel overlapping with the at least one synchronization signal in frequency.

58. The apparatus according to claim 48, wherein the synchronization signal block comprises:
a first orthogonal frequency division multiplexing (OFDM) symbol comprising a primary synchronization signal on a subset of a plurality of subcarriers;
a second OFDM symbol comprising resource elements of the data channel at the plurality of subcarriers;
a third ODFM symbol comprising a secondary synchronization signal on the subset of the plurality of subcarriers and resource elements of the data channel at edges of the plurality of subcarriers; and
a fourth OFDM symbol comprising resource elements of the data channel at the plurality of subcarriers.

59. The apparatus according to claim 48, wherein the instructions, when executed by the at least one processor, cause the apparatus to:
jointly decode the data based on a plurality of the synchronization signal blocks.

60. A method, comprising:
receiving a synchronization signal block of a transmission frame, wherein the synchronization signal block comprises a data channel;
extracting data from resource elements of the data channel, wherein the extraction of the data from the resource elements of the data channel is dependent on a frame number of the transmission frame; and
decoding the data.
